(19) United States
(12) Patent Application Publication
(10) Pub. No.: US 2015/0279340 A1
(43) Pub. Date: Oct. 1, 2015

(54) TREMOLO (VIBRATO) BRIDGE

(71) Applicant: Andrew PRESTON, Monmouthshire, Gwent (GB)

(72) Inventor: Andrew Preston, Monmouthsire (GB)

(21) Appl. No.: 14/432,576

(22) PCT Filed: Oct. 1, 2013
(86) PCT No.: PCT/GB2013/052550

§ 371 Date: Mar. 31, 2015

(30) Foreign Application Priority Data
Oct. 2, 2012 (GB) 1217632.7
Aug. 14, 2013 (GB) 1314545.3

(51) Int. Cl. G10D 3/14

(52) U.S. Cl. CPC G10D 3/146

(57) ABSTRACT

A bridge plate for a tremolo (vibrato) bridge which has recesses on the top surface to facilitate a pivot on a constant pivot point. A shim which is placed between the bridge plate and the body of the guitar. A saddle can be associated with the bridge plate, to receive the guitar string and to adjust a height of the string and a distance from a nut of the guitar to the portion at which the string rests on the saddle. A block can be fitted to the underside of the bridge plate to receive the guitar string. A tremolo arm can be attached to the block, with springs to counteract the force of the string thereby establishing a stable position. This ensures that an angle of the bridge plate in a balanced position is always the same, thereby solving the problems of tuning stability.

### CROSS-REFERENCE TO RELATED APPLICATIONS

This application is an U.S. national phase application under 35 U.S.C. §371 based upon co-pending International Application No. PCT/GB2013/052550 filed on Oct. 1, 2013. Additionally, this U.S. national phase application claims the benefit of priority of co-pending International Application No. PCT/GB2013/052550 filed on Oct. 1, 2013, Great Britain Application No. 1217632.7 filed on Oct. 2, 2012 and Great Britain Application No. 1314545.3 filed on Aug. 14, 2013. The entire disclosures of the prior applications are incorporated herein by reference. The international application was published on Apr. 10, 2014 under Publication No. WO 2014/053819.

### BACKGROUND OF THE INVENTION

1. Field of the Invention

The invention is related to the tremolo bridge of a guitar.

2. Description of the Prior Art

The Fender Stratocaster was introduced in the early 1950's. The tremolo bridge (also referred to as a vibrato bridge) fitted to the early guitars and other similar guitars, all experience a problem with tuning stability. This type of bridge is widely known in the market place as a six screw mount, vintage style tremolo bridge. It is still fitted to a wide range of guitars from Fender as well as other manufacturers to this date. This is because customers often prefer the character of the sound of the guitar (also described as tone) produced with this style of six screw mount vintage style tremolo bridge.

There exist products currently on the market designed correct the inherent design flaws of the six screw mount vintage tremolo bridges and stabilize tuning. They are generally quite complicated and sometimes require modification to the body of the guitar. In addition the character of the guitars sound will be affected by design and materials used.

Accordingly, there still exists a need in the art for a tremolo bridge which fixes the problem of tuning stability and also delivers a faithful replication/enhancement of the character of sound produced by the early 6 screw mount vintage tremolo bridge.

### SUMMARY OF THE INVENTION

In view of the foregoing disadvantages inherent in the known types of tremolo or vibrato bridges now present in the prior art, the present invention provides an improved tremolo bridge, and overcomes the above-mentioned disadvantages and drawbacks of the prior art. As such, the general purpose of the present invention, which will be described subsequently in greater detail, is to provide a new and improved tremolo bridge and method which has all the advantages of the prior art mentioned heretofore and many novel features that result in a tremolo bridge which is not anticipated, rendered obvious, suggested, or even implied by the prior art, either alone or in any combination thereof.

To attain this, the present invention essentially comprises a bridge plate associated with a body of a guitar. The bridge plate has a top surface, a bevel on an underside of the bridge plate, at least one fixing hole defined through the bridge plate, and at least one recess defined in the top surface. A mounting fixing is received through the fixing hole and into the body of the guitar. A portion of the mounting fixing that is located above the top surface of the bridge plate is accommodated in the recess when the bridge plate is tilted, enabling the bridge plate to tilt on at least one aligned constant pivot point, whilst also maintaining contact via the bevel on the underside of the bridge plate, to the body of the guitar.

A saddle can also be associated with the bridge plate, with at least one string of the guitar resting on a portion of the saddle. The saddle has at least one saddle hole configured to receive the string of the guitar therethrough. The saddle is configured to adjust a height of the string and a distance from a nut of the guitar to the portion at which the string rests on the saddle.

The recess, mounting fixing and pivot point are each located below at least one string of the guitar, with the bridge plate defining at least one string hole configured to receive the string therethrough.

There has thus been outlined, rather broadly, the more important features of the invention in order that the detailed description thereof that follows may be better understood and in order that the present contribution to the art may be better appreciated.

The invention may also include a block fitted to the underside of the bridge plate. The block has a block hole defined therethrough aligned with the string hole of the bridge plate and with the saddle hole. The block hole is configured to receive the string of the guitar. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved tremolo bridge that has all of the advantages of the prior art and none of the disadvantages.

It is another object of the present invention to provide a new and improved tremolo bridge that may be easily and efficiently manufactured and marketed.

An even further object of the present invention is to provide a new and improved tremolo bridge that has a low cost of manufacture with regard to both materials and labor, and which accordingly is then susceptible of low prices of sale to the consuming public, thereby making such tremolo bridge economically available to the buying public.

Still another object of the present invention is to provide a new tremolo bridge that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side cross-sectional view of an embodiment of the tremolo bridge constructed in accordance with the principles of the present invention.

FIG. 2 is a top elevational view of the bridge plate of the present invention.

FIG. 3 is a top elevational view of the tone shim of the present invention.

FIG. 4 is a cross-sectional view of the constant pivot point of the present invention.

FIG. 5 is a bottom elevational view of the bridge plate of the present invention.

The same reference numerals refer to the same parts throughout the various figures.

### DETAILED DESCRIPTION OF THE INVENTION

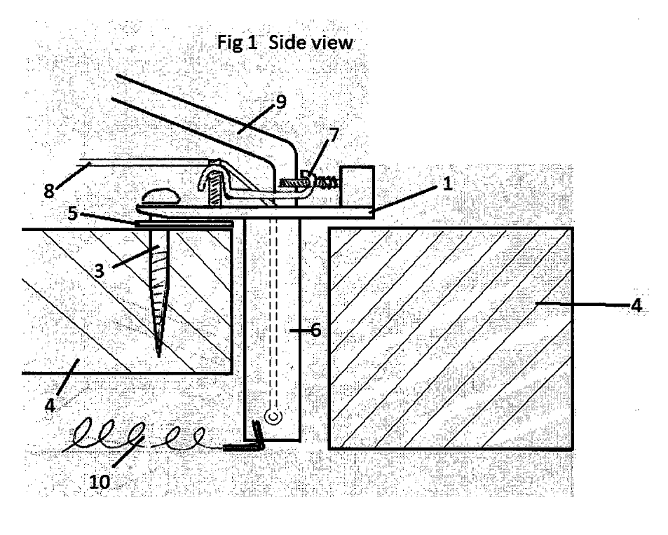

Referring now to the drawings, and particularly to FIGS. 1-5, an embodiment of the tremolo bridge of the present invention is shown and generally designated.

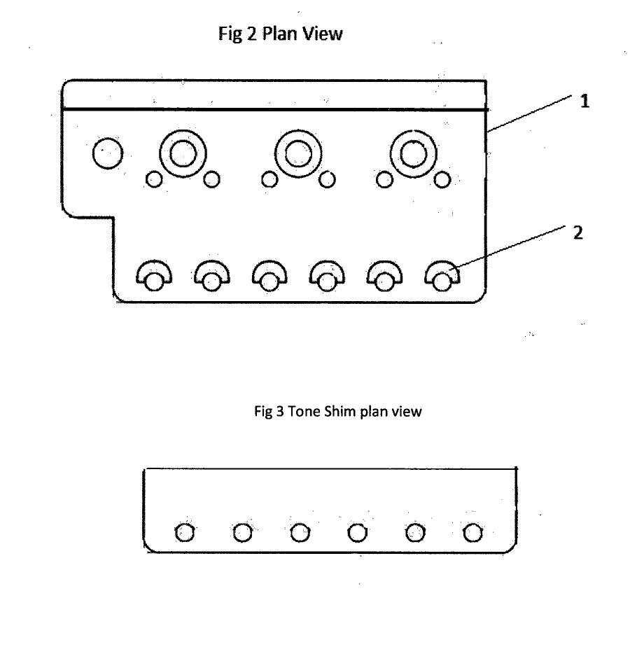

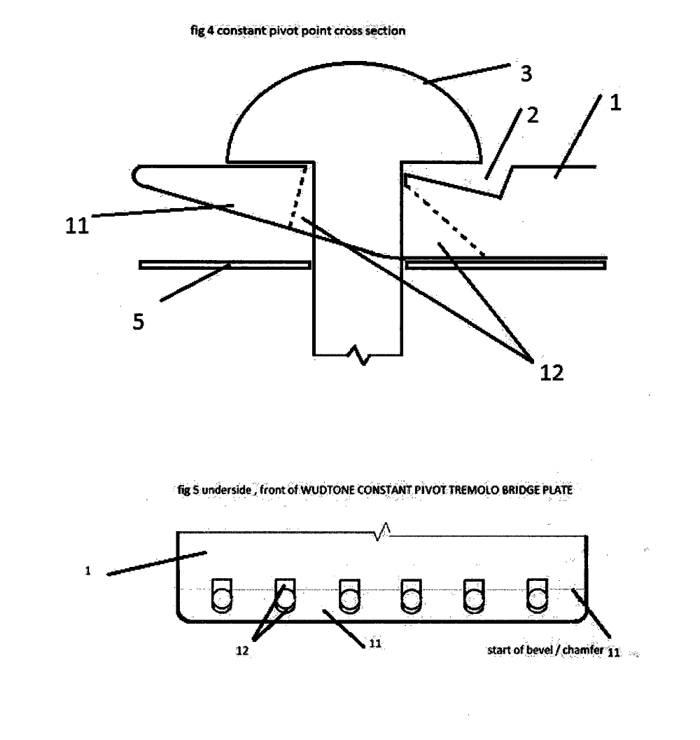

In FIG. 1, a new and improved tremolo bridge of the present invention is illustrated and will be described. More particularly, the present invention is part of a bridge assembly, made up from a Wudtone™ constant pivot tremolo bridge plate 1 with angled recesses 2, as best illustrated in FIGS. 2 and 4, in the top surface to accommodate the heads of a number of bearing screws or bolts (also known as mounting screws or bolts) 3.

Between the body of the guitar 4 and the bridge plate 1, lies on an optional tone shim 5 which has holes, as best illustrated in FIG. 3, through which the bearing screws 3 pass. The bridge plate 1 also has holes which enable a tone block 6 to be fitted under the bridge plate 1. The bridge plate 1 has holes to enable the fitting of bridge saddles 7. Strings 8 are inserted in the bottom of the tone block 6, which pass through the holes in the tone block 6 which align with holes in the bridge plate 1 and elongated holes in the saddles 7. The saddles 7 offer adjustment in height of the string 8 and distance from the guitars' nut to the point at which the string 8 rests on the saddle 7 to ensure correct intonation.

A tremolo arm 9 passes through a hole in the bridge plate 1 and then screws into the tone block 6. Springs 10 connect to the bottom of the tone block 6 and to the body of the guitar to counteract the force of the strings 8 to establish a stable position. As the tremolo arm 9 is moved up and down, the bridge plate 1 pivots on the bearing screws 3 at a point which stays constant. This ensures that the angle of the bridge plate 1 in the balanced position is always the same. This in turn fixes the problems of tuning stability.

As best illustrated in FIGS. 4 and 5, it is noted that the bridge plate 1 also has a chamfer/bevel on the lower front surface 11 to accommodate movement thereof whilst maintaining connection with the body of the guitar 4 or a shim 5 if fitted thereto.

It is additionally noted that the plate 1 is also relieved in a specific areas 12 to facilitate any movement below the horizontal and prevent any lateral binding whilst also being cut in such a way, as best illustrated in FIG. 5, so as to maximize area of contact on the underside of the bridge plate 1, between the bevel/chamfer 11 and the body of the guitar 4 or shim 5 if fitted thereto.

While embodiments of the tremolo bridge have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-5. (canceled)

6. A tremolo bridge plate for use with a guitar, said tremolo bridge plate comprising:
a bridge plate having a top surface, a bevel on an underside of said bridge plate, at least one fixing hole defined through said bridge plate, and at least one recess defined in said top surface, and
at least one mounting fixing received through said fixing hole and into the body of the guitar;
wherein a portion of the mounting fixing located above said top surface of said bridge plate is accommodated in said recess when said bridge plate is tilted, enabling said bridge plate to tilt on at least one aligned constant pivot point, whilst also maintaining contact via said bevel on said underside of said bridge plate, to the body of the guitar.

7. The tremolo bridge plate according to claim 6 further comprising at least one saddle associated with said bridge plate, at least one string of the guitar rests on a portion of said saddle, said saddle having at least one saddle hole defined therethrough configured to receive the string of the guitar therethrough, said saddle is configured to adjust a height of the string and a distance from a nut of the guitar to said portion at which the string rests on said saddle.

8. The tremolo bridge plate according to claim 7 further comprising a block fitted to said underside of said bridge plate, said block having a block hole defined therethrough aligned with at least one string hole defined in said bridge plate and with said saddle hole, said block hole is configured to receive the string of the guitar.

9. The tremolo bridge plate according to claim 8 further comprising at least one spring connected to a bottom portion of said block, wherein the string is attached to said bottom portion of said block, said spring is configured to counteract a force of the string.

10. The tremolo bridge plate according to claim 9 further comprising a tremolo arm attachable to said block, wherein upon movement of said tremolo arm said bridge plate is configured to pivot on said mounting fixing at a constant point to ensure that an angle of said bridge plate in a balanced position is always the same.

11. The tremolo bridge plate according to claim 10, wherein said tremolo arm passes through an arm hole defined through said bridge plate.

12. The tremolo bridge plate according to claim 6, wherein said fixing hole further defines a relief area configured to receive movement of a portion of said mounting fixing received in said fixing hole.

13. The tremolo bridge plate according to claim 12, wherein said relief area additionally being configured to prevent lateral binding of said mounting fixing, and configured to create an area of contact on said underside of said bridge plate, between said bevel and the body of the guitar.

14. The tremolo bridge plate according to claim 6, wherein said recess is located adjacent said fixing hole, and wherein at least one string hole is defined in said bridge plate and aligned with said fixing hole and said recess.

15. The tremolo bridge plate according to claim 14, wherein said fixing hole is a plurality of fixing holes, said recess is a plurality of recesses, said string hole is a plurality of said string holes, and said mounting fixing is a plurality mounting fixings, wherein each of said fixing holes receive at least one of said mounting fixings, and each of said string holes receives at least one string of the guitar.

16. The tremolo bridge plate according to claim 6 further comprising a shim located between said bridge plate and the body of the guitar, said shim having at least one shim hole defined therethrough, said shim hole is configured to receive said mounting fixing therethrough to create contact between said shim and a moving point of contact of said bevel on said underside of said bridge plate when tilting.

17. The tremolo bridge plate according to claim 6, wherein said recess, said mounting fixing and said pivot point are each located below at least one string of the guitar.

18. A tremolo bridge plate system comprising:
a guitar having a plurality of strings, and a body; and
a bridge plate associated with said body of said guitar, said bridge plate comprising:
a top surface, a bevel on an underside of said bridge plate, at least one fixing hole defined through said bridge plate, at least one recess defined in said top surface, and at least one string hole defined through said bridge plate, said recess being located below at least one of said strings of said guitar; and
at least one mounting fixing received through said fixing hole and into said body of said guitar, said mounting fixing being located below at least one of said strings of said guitar;
wherein a portion of the mounting fixing located above said top surface of said bridge plate is accommodated in said recess when said bridge plate is tilted, enabling said bridge plate to tilt on at least one aligned constant pivot point under the string, whilst also maintaining contact via said bevel on said underside of said bridge plate, to said body of said guitar.

19. The tremolo bridge plate according to claim 18 further comprising at least one saddle associated with said bridge plate, said at least one of said strings of said guitar rests on a portion of said saddle, said saddle having at least one saddle hole defined therethrough configured to receive said at least one of said strings of said guitar therethrough, said saddle is configured to adjust a height of said at least one of said strings and a distance from a nut of said guitar to said portion at which said at least one of said strings rests on said saddle.

20. The tremolo bridge plate according to claim 19 further comprising a block fitted to said underside of said bridge plate, said block having a block hole defined therethrough aligned with said string hole of said bridge plate and with said saddle hole, said block hole is configured to receive said at least one of said strings of said guitar.

21. The tremolo bridge plate according to claim 20 further comprising at least one spring connected to a bottom portion of said block, wherein said at least one of said strings is attached to said bottom portion of said block, said spring is configured to counteract a force of said at least one of said strings.

22. The tremolo bridge plate according to claim 21 further comprising a tremolo arm attachable to said block, wherein upon movement of said tremolo arm said bridge plate is configured to pivot on said mounting fixing at a constant point to ensure that an angle of said bridge plate in a balanced position is always the same.
